(19) United States
(12) Patent Application Publication
(10) Pub. No.: US 2009/0293683 A1
(43) Pub. Date: Dec. 3, 2009

(54) RATCHET DRIVER

(76) Inventor: Chia-Yu CHEN, Taichung (TW)

Correspondence Address: SINORICA, LLC, 2275 Research Blvd., Suite 500, ROCKVILLE, MD, 20850, US

(21) Appl. No.: 12/131,181

(22) Filed: Jun. 2, 2008

(51) Int. Cl. B25B 13/46; B25B 15/04

(52) U.S. Cl. 81/63.1; 81/436

(57) ABSTRACT

A ratchet driver includes a grip and a ratchet unit having a positioning base with a central through hole. The positioning base is mounted by a ratchet wheel and a direction-changing ring, having two accommodating grooves formed in its one side for respectively fitting a locking piece. An U-shaped groove is formed along the central through hole between the accommodating grooves, used for fitting an elastic element made of an elastic plate and having its two ends extended into the accommodating grooves to elastically rest on and strongly push the locking pieces while turning around the direction-changing ring, able to withstand a great integral torsion generated while turning the grip to drive the ratchet wheel and a driving head. Also, the ratchet driver has a simple structure, convenient to assemble and disassemble.

### BACKGROUND OF THE INVENTION

1. Field of the Invention

This invention relates to a ratchet driver, particularly to one having an elastic element able to provide a great torsion while whirling a grip to drive a ratchet wheel and a driving head.

2. Description of the Prior Art

As shown in FIGS. 1 and 2, a conventional ratchet driver is composed of a grip 10, a ratchet unit 20 installed with the grip 10 and a driving head 30 driven by the ratchet unit 20. The ratchet unit 20 includes a positioning base 21 provided with a central through hole (a), a connecting portion 211 formed at its one side for fixing with the grip 10, and a positioning portion 212 formed at another side for being mounted by a ratchet wheel 40 having plural teeth 41 formed around its interior wall. Two accommodating grooves 213 are respectively and axially formed at two sides of the central through hole (a), paralleling to each other for respectively containing a U-shaped locking piece 22 and a compression spring 23 able to press the locking piece 22 to move outward. A direction-changing ring 24 is mounted around the positioning portion 212 between the ratchet wheel 40 and the grip 10, provided with two locking grooves 241 cut in its inner wall to respectively correspond to a locking end 221 of each of the locking pieces 22 for restricting the direction-changing ring 24 to change direction. The locking groove 241 has its two sides respectively formed with a guiding slope 242. Installed between the direction-changing ring 24 and the positioning base 21 is a positioning member 25 employed to restrictively let the locking pieces 22 change direction. Formed in the inner wall of the direction-changing ring 24 to correspond to the locking grooves 241 are three consecutive positioning grooves 243. The positioning member 25 is provided with a hole 251 dug in the positioning portion 212 to correspond to one of the positioning grooves 243, a compression spring 252 put in the hole 251, and a steel ball 253 laid on and ever forced by the compression spring 252 to fit in the positioning groove 243 of the direction-changing ring 24.

In using, when the direction-changing ring 24 is turned around in a preset direction, the locking ending 221 of one of the locking pieces 22 is restrictively positioned in the locking groove 241 and the accommodating groove 213 by being pressed down through the slope 242 by the compression spring 23, and the locking end 221 of the other locking piece 22 is engaged with one of the teeth 41 of the ratchet wheel 40 by pressing the compression spring 23 to lean on the inner wall of the direction-changing ring 24 next to the slope 242. And, by means of the positioning member 25, the direction-changing ring 24 can be turned around and positioned in one direction, so that the ratchet wheel 40 can drive the driving head 30 to turn a screw in a single direction.

However, as the engagement between the locking pieces 22 and the teeth 41 of the ratchet wheel 40 is based on their one side with only an axial force provided by the compression spring 23, its combination is so poor that it can not have sufficient torsion to support the operation of the ratchet driver. Moreover, the locking pieces 22 are to linearly move corresponding to the positioning base 21 while turning the direction-changing ring 24.

### SUMMARY OF THE INVENTION

The object of this invention is to offer a ratchet driver provided with an elastic element able to effectively press on a surface of locking pieces to keep the locking pieces elastically engaged with teeth of a ratchet wheel, so as to withstand a great integral torsion generated while turning a grip to drive the ratchet wheel and a driving head. And, the elastic element is not to easily get fatigued after having been used for a long period of time.

The ratchet driver includes the grip, a ratchet unit installed with the grip, and a driving head used to drive a screw. The ratchet unit includes a positioning base provided with a central through hole, a connecting portion fixed with the grip, and a positioning portion mounted by a ratchet wheel having its inner wall formed with teeth. The positioning portion is provided with at least two accommodating grooves axially formed in its one side and paralleling to each other for respectively containing a locking piece and an elastic element. A direction-changing ring is mounted around the positioning portion between the ratchet wheel and the grip, provided with two locking grooves formed in its inner wall to respectively correspond to an opening of each of the accommodating grooves for supporting the locking pieces to carry out changing direction. A positioning member is fixed between the direction-changing ring and the positioning base to restrictively let the locking pieces change direction. The positioning base is provided with a U-shaped groove that is axially concaved in a front end of the positioning portion, with a central bottom corresponding to the opposite side of the axial openings of the accommodating grooves, and with two openings formed at its two sides to axially surround the central through hole of the positioning base with a proper space so as to keep the U-shaped groove positioned between the accommodating grooves. A U-shaped open groove 514 is axially formed in the U-shaped groove between the accommodating grooves by a proper depth so as to enable two corresponding sides of the accommodating grooves to communicate with an opening of the U-shaped groove. And, an elastic element made of an elastic plate is fitted in the U-shaped groove, with its two free ends extending into the accommodating grooves to respectively rest on their inner sides elastically without exceeding an inner wall of the direction-changing ring.

With the free ends of the elastic element to effectively press on a surface of the locking pieces, the locking ends of the locking pieces can be elastically engaged with the teeth of the ratchet wheel to provide a great torsion while whirling the grip along the central through hole of the positioning base to drive a driving head. And, the elastic element is not to easily get fatigued after used for a long period of time. Moreover, the ratchet driver has a simple structure, convenient to be assembled and disassembled

### BRIEF DESCRIPTION OF DRAWINGS

This invention is better understood by referring to the accompanying drawings, wherein:

FIG. 1 is a an exploded perspective view of a conventional ratchet driver;

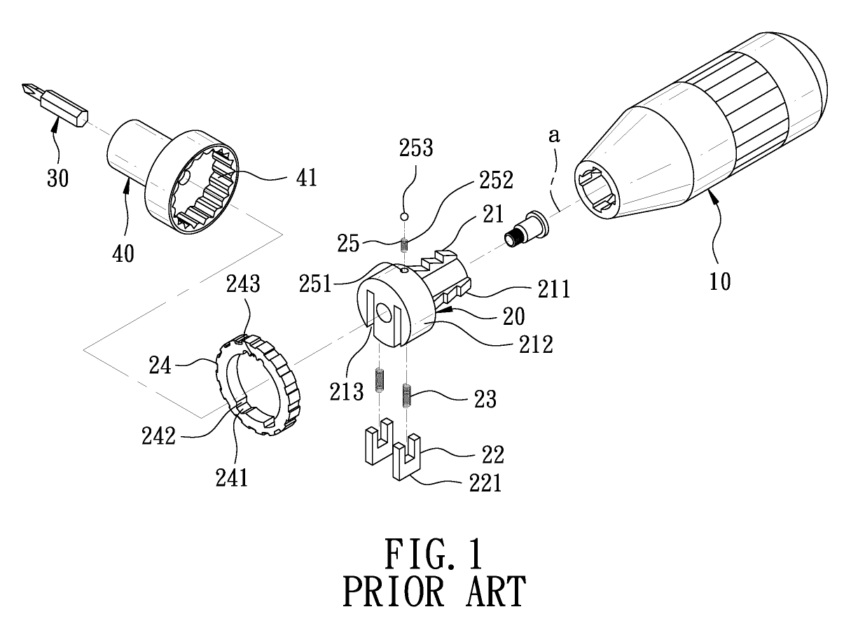

FIG. 2 is a cross-sectional view of the conventional ratchet driver, showing a direction-changing ring being positioned after having driven locking pieces to alter direction;

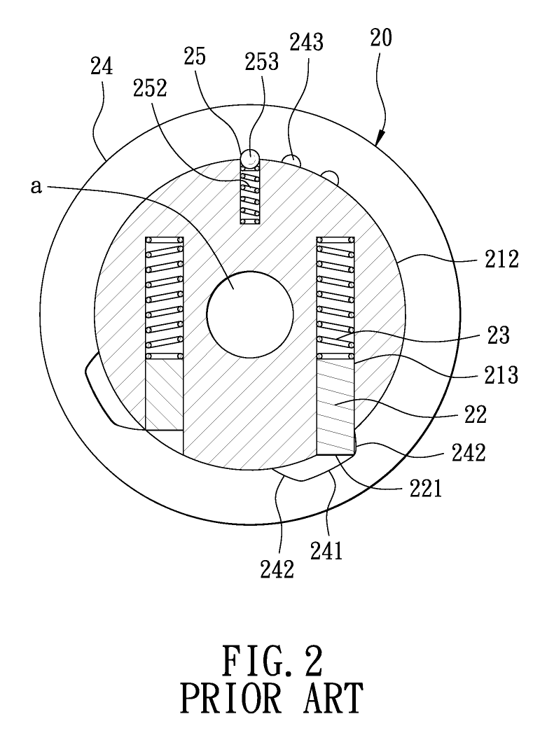

FIG. 3 is a an exploded perspective view of a preferred embodiment of a ratchet driver in the present invention;

FIG. 4 is a cross-sectional view of the preferred embodiment of a ratchet driver in the present invention;

FIG. 5A is a cross-sectional view of the line A-A in FIG. 4, showing engagement of locking pieces of a positioning base and locking grooves of a direction-changing ring while having the direction-changing ring positioned in an intermediate positioning groove;

FIG. 5B is a cross-sectional view of the line B-B in FIG. 4, showing engagement of the locking pieces of the positioning base and teeth of a ratchet wheel while having the direction-changing ring positioned in the intermediate positioning groove;

FIG. 6A is a cross-sectional view of the line A-A in FIG. 4, showing engagement of the locking pieces of the positioning base and the locking grooves of the direction-changing ring while having the direction-changing ring positioned in a left positioning groove; and

FIG. 6B is a cross-sectional view of the line B-B in FIG. 4, showing engagement of the locking pieces of the positioning base and teeth of the ratchet wheel while having the direction-changing ring positioned in the left positioning groove.

### DETAILED DESCRIPTION OF THE PREFERRED EMBODIMENT

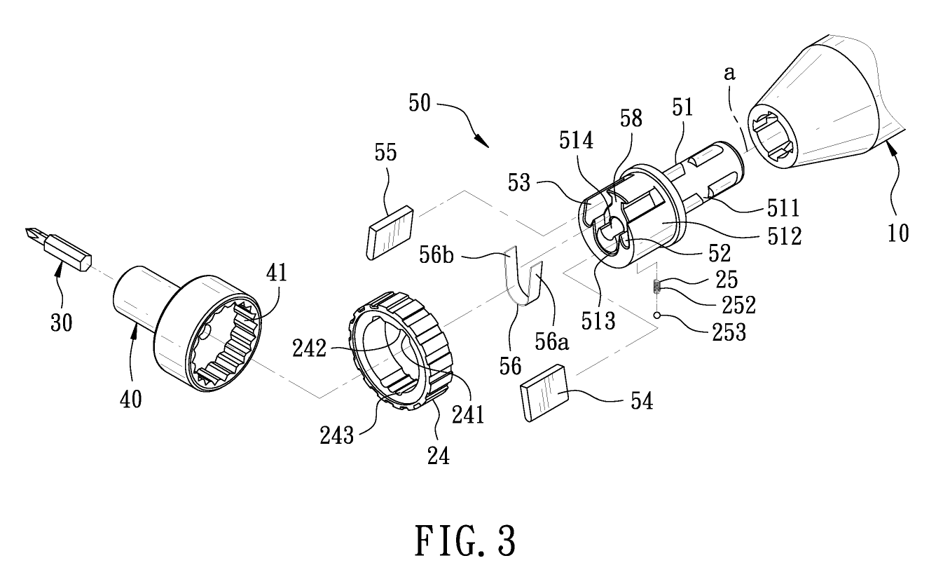

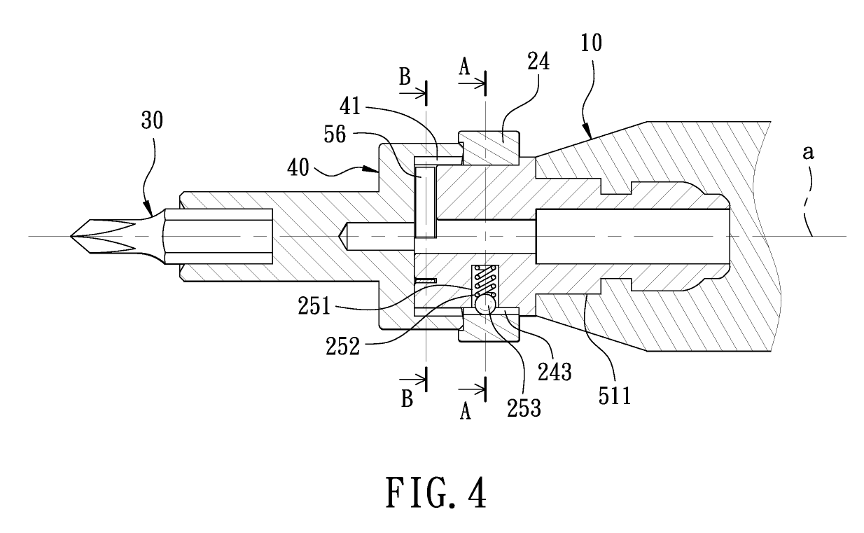

As shown in FIGS. 3 and 4, a preferred embodiment of a ratchet driver in the present invention has the same components as the conventional one does, except that the ratchet unit 20 in the conventional one is replaced with a ratchet unit 50. Thus, the ratchet driver of the invention is composed of the grip 10, the ratchet unit 50 installed with the grip 10 and the driving head 30 driven by the ratchet unit 50. The ratchet unit 50 includes a positioning base 51 provided with a central through hole (a), a connecting portion 511 formed at its one side for fixing with the grip 10, and a positioning portion 512 formed at another side for being mounted by the ratchet wheel 40. Two accommodating grooves 52 and 53 are respectively and axially formed at two sides of the central through hole (a), paralleling to each other for respectively fitting a locking piece 54 and 55, which are separated by an elastic element 56. The locking grooves 241 of the direction-changing ring 24 are formed to correspond to the accommodating grooves 52 and 53 for being fitted by the locking pieces 54 and 55 to turn around. Installed between the direction-changing ring 24 and the positioning base 51 is the positioning member 25 employed to drive and fix the locking pieces 54 and 55. The improvement made in the invention is described below.

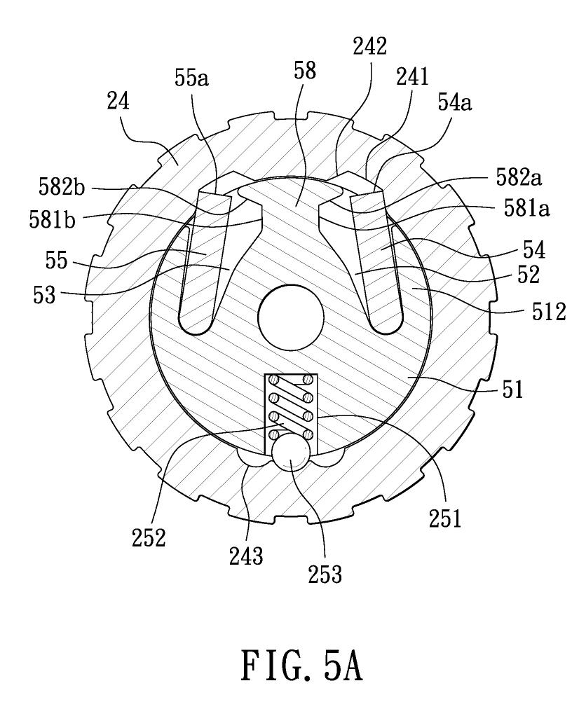

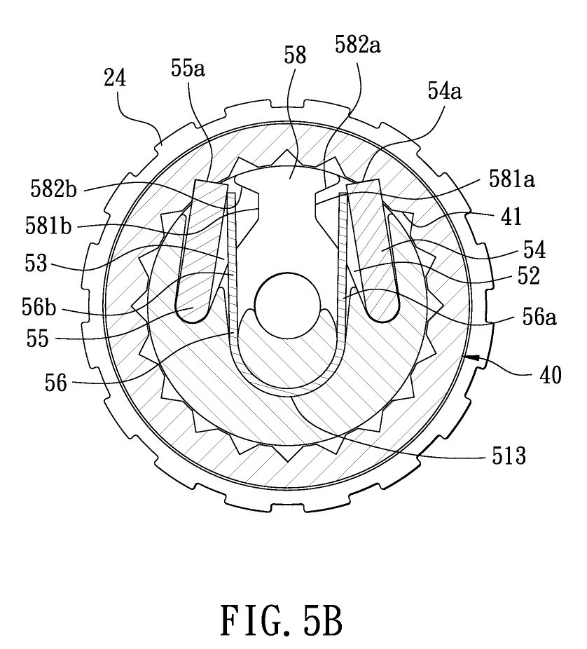

The positioning base 51 is provided with a U-shaped groove 513 that is axially formed in a front end of the positioning portion 512, with a central bottom corresponding to the opposite side of the axial openings of the accommodating grooves 52 and 53, and with two openings formed at its two sides to axially surround the central through hole (a) of the positioning base 51 with a proper space so as to keep the U-shaped groove 513 positioned between the accommodating grooves 52 and 53, which are as well formed as an U shape. A U-shaped open groove 514 is axially formed in the U-shaped groove 513 by a proper depth and between the accommodating grooves 52 and 53, enabling the corresponding sides of the accommodating grooves 52 and 53 to communicate with the opening of the U-shaped groove 513. In addition, formed at a rear end of the positioning portion 512 between the accommodating grooves 52 and 53 is a positioning member 58. As shown in FIG. 5A, which is a cross-sectional view of the line A-A in FIG. 4 and shows the direction-changing ring 24 being turned around to keep the positioning member 25 positioned in the intermediate one of the positioning grooves 243, the positioning member 58 is provided with two leaning surfaces 581a and 581b formed by tapering its neck, and two restricting surfaces 582a and 582b respectively formed by expanding upward from the leaning surfaces 581a and 581b. One of the locking pieces 54 and 55 can be driven to rest on the corresponding leaning surfaces 581a and 581b and the accommodating grooves 52 and 53. When the locking pieces 54 and 55 rest on the leaning surfaces 581a and 581b, they are to be restrictively positioned by the restricting surfaces 582a and 582b.

The elastic element 56 is made of an elastic plate, fitted in the U-shaped groove 513 of the positioning base 51 and axially surrounding the central through hole (a) of the positioning base 51. And, two free ends 56a and 56b of the elastic element 56 extending into the accommodating grooves 52 and 53 respectively rest on their inner sides elastically, without exceeding the locking grooves 241 of the direction-changing ring 24, enabling them to extend through the open groove 514 in parallel so as to provide a longitudinal pushing force and an axial central supporting elasticity for the locking pieces 54 and 55.

In order to further understand the structural features, operative techniques and expected effects of the invention, how to use the invention is to be described below.

As shown in FIG. 5A again, while the direction-changing ring 24 is moved to a middle position, with the steel ball 253 pushed by the compression spring 252 to keep the positioning member 25 fixed in the intermediate one of the positioning grooves 243, the locking pieces 54 and 55 are not to have their driving ends 54a and 55a contacted with the locking grooves 241 of the direction-changing ring 24. And, as shown in FIG. 5B, which is a cross-sectional view of the line B-B in FIG. 4 and shows the direction-changing ring 24 being turned around to keep the positioning member 25 positioned in the intermediate one of the positioning grooves 243, the locking pieces 54 and 55 are pressed by the elastic element 56 to keep the driving ends 54a and 55a engaged with the teeth 41 of the ratchet wheel 40, so that the driving head 30 can be whirled in two directions to drive a screw while rotating the grip 10.

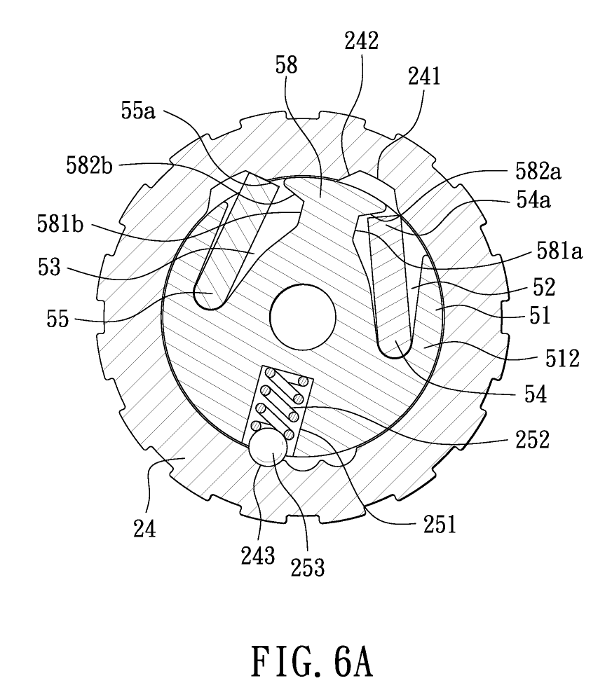

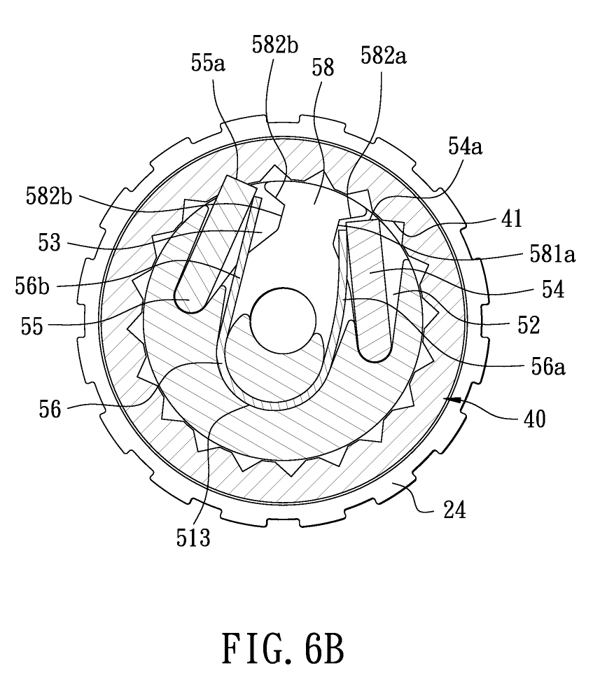

FIG. 6A is a cross-sectional view of the line A-A in FIG. 4, showing the direction-changing ring 24 being turned around to keep the positioning member 25 positioned in the side positioning groove 243. When the ratchet driver is to be altered in its operating direction, the direction-changing ring 24 can be clockwise rotated, with the steel ball 253 pushed by the compression spring 252 to keep the positioning member 25 fitted in the left positioning groove 243. And, FIG. 6B is a cross-sectional view of the line B-B in FIG. 4, showing the engagement of the locking pieces 54 and 55 and the teeth 41 of the ratchet wheel 40 while having the direction-changing ring 24 turned around to be positioned in the left positioning groove 243. By the time, the driving end 55a of the locking piece 55 extends into the locking groove 241 to rest on the slope 242, and the driving end 54a of the locking piece 54 is guided by the slope 242 to move up and rest on the inner wall of the direction-changing ring 24. The free ends 56a and 56b of the elastic element 56 can thus press the leaning surfaces 581a and 581b in the accommodating grooves 52 and 53 to keep the locking pieces 54 and 55 restrictively positioned by the restricting surfaces 582a and 582b. So, while operating the ratchet driver, the driving end 55a of the locking piece 55 can be strongly engaged with the tooth 41 of the ratchet wheel 40 by a powerful elastic force of the free end 56b of the elastic element 56, enabling the positioning base 51 to generate a great torsion to keep the driving head 30 work smoothly. On the contrary, when the direction-changing ring 24 is turned around another direction, the locking pieces 54 and 55 can be driven to alter their direction by a way the same as that described previously.

While the preferred embodiment of the invention has been described above, it will be recognized and understood that various modifications may be made therein and the appended claims are intended to cover all such modifications that may fall within the spirit and scope of the invention.

What is claimed is:

1. A ratchet driver comprising a grip, a ratchet unit installed with said grip and connected with a driving head to drive a screw and provided with a positioning base that has a central through hole, a connecting portion combined fixedly with said grip and a positioning portion mounted by a ratchet wheel having its inner wall formed with teeth, said positioning portion provided with at least two accommodating grooves axially formed in its one side and paralleling to each other for respectively containing a locking piece, an elastic element elastically resting on said locking pieces, a direction-changing ring mounted around said positioning portion of said ratchet unit between said ratchet wheel and said grip and provided with two locking grooves formed in its inner wall to respectively correspond to an opening of each of said accommodating grooves for supporting said locking pieces to carry out changing direction, a positioning member fixed between said direction-changing ring and said positioning base to restrictively let said locking pieces change direction, said ratchet driver characterized by:
said positioning base provided with a U-shaped groove that is axially concaved in a front end of said positioning portion, having a central bottom corresponding to an opposite side of axial openings of said accommodating grooves, two openings formed at two sides of said U-shaped groove to axially surround said central through hole of said positioning base with a proper space so as to keep said U-shaped groove positioned between said accommodating grooves, a U-shaped open groove axially formed in said U-shaped groove between said accommodating grooves by a proper depth so as to enable two corresponding sides of said accommodating grooves to communicate with an opening of said U-shaped groove; and
said elastic element made of an elastic plate and bent to fit in said U-shaped groove of said positioning base and axially surrounding said central through hole of said positioning base, two free ends of said elastic element extending into said accommodating grooves to respectively rest on their inner sides elastically without exceeding an inner wall of said direction-changing ring.

2. The ratchet driver as claimed in claim 1, wherein said positioning base includes a positioning member formed between said accommodating grooves and provided with two leaning surfaces formed by tapering its neck, two restricting surfaces respectively formed by expanding upward from said leaning surfaces, so as to keep one of said locking pieces changing direction to rest on said corresponding leaning surfaces and said accommodating grooves and positioned by said restricting surfaces.
